(19) United States
(12) Patent Application Publication
(10) Pub. No.: US 2005/0029343 A1
(43) Pub. Date: Feb. 10, 2005

(54) Patient card

(76) Inventor: Peter-Joachim Neymann, Herten (DE)

Correspondence Address: WILLIAM COLLARD;COLLARD & ROE, P.C., 1077 NORTHERN BOULEVARD, ROSLYN, NY, 11576, US

(21) Appl. No.: 10/490,354

(22) PCT Filed: Mar. 22, 2002
(86) PCT No.: PCT/EP02/03244

(30) Foreign Application Priority Data
Sep. 20, 2001 (DE) 201 15 536.2

(51) Int. Cl. G06K 5/00

(52) U.S. Cl. 235/380

(57) ABSTRACT

The invention relates to a patient card with a chip, provided with an integrated memory in which personal data for a patient are recorded. According to the present invention, said card comprises a sensor field, which permits a fingerprint to be matched with recorded fingerprint data, as well as a program control, which permits the patient data, recorded in said integrated memory, to be released in case of recorded and detected fingerprint data matching.

The invention relates to a patient card, particularly one having a microchip having an integrated data memory, in which personal data of a patient are stored.

The use of such patient insurance cards has become common. These cards serve primarily to provide the treating physician with proof of insurance and, at the same time, to make the necessary administrative data available. Usually, chip cards in the form of a check card made of plastic are used as patient insurance cards; a highly integrated, programmable microprocessor having a memory is located on the card For the user, such chip cards can generally be recognized by means of the metal contact surfaces on the surface. Recently, however, contact-free systems, so-called transponder cards, also exist, in which the data exchange takes place by way of an induction antenna integrated into the card. In the case of usual chip cards, the data memory is divided up, in most cases, into a ROM region for the operating system, i.e. the permanent card software parts, and an EEPROM region, which serves to store variable values. In the case of modern chip cards, the data stored on the chip are protected against being read out, so that unauthorized copying is made essentially impossible. The data exchange with suitable read/write devices is carried out by means of the microprocessor, by implementation of suitable data transfer protocols.

The data content of usual patient insurance cards is subject to the provisions of data privacy laws. Patient insurance cards used nowadays as a substitute for the health insurance certificates issued by the statutory health insurance do not contain any kind of medical data, and merely serve, as mentioned above, to document entitlement to the use of services, as well as for settlement of accounts with the service providers. The health insurance card therefore contains information about the name of the issuing health insurance, the last name and first name of the insured, the address, the health insurance number, the insured status, the date of the start of insurance protection, as well as the date on which the card expires, if it has an expiration date. The card contains the signature of the insured on the back of the card.

To an increasing degree, possibilities of using machine-readable patient cards that go beyond this have been discussed and tested, in recent times. For example, DE 195 36 204 A1 proposes using chip cards of the type stated initially to transfer and store medical/clinical data. The card particularly serves to make diagnostic and medication data of the patient available in any emergency, if it occurs, so that it can be determined, for example, whether there might be interactions between medications selected for medication therapy, or contraindications with regard to allergies to medications. With regard to the data privacy problem mentioned above, the aforementioned patent application proposes using encryption technologies for storing the relevant data, whereby access to the encrypted data takes place by means of an entitlement code (PIN), which only the cardholder has. With regard to emergency use, it is furthermore proposed that emergency physicians can also be authorized to have access to encrypted data.

However, such cards are problematic if the cardholder is not responsive, due to illness or accident, or dies. In this case, the entitlement code of the cardholder is generally no longer available. The data stored on the card are no longer available for measures to be initiated or for treatment. In general, it is also not possible to obtain these data from the patient's family, at short notice.

A particular problem occurs if, for example, a person suddenly dies in an accident. The donation, removal, and transfer of human organs by a doctor is permissible in the case of a deceased donor if the organ donor has given his/her permission and his/her death (brain death) has been pronounced. On the other hand, removing organs is not permitted if the organ donor has not given permission. If there is no declaration in this regard, the permission of the next of kin, for example the spouse, is required. Since there is a great need for organ donations, information about the possibility of donating organs is especially supposed to be provided by way of the health insurance organizations, and the insured are to be requested to issue a declaration concerning organ donation, a so-called living will. In this document, the permission or lack of permission for organ donation is recorded, or the decision is transferred to a designated third party.

If the death of a patient suddenly occurs in an emergency situation, there is the problem of determining, in the shortest possible period of time, whether the potential organ donor has given permission or refused permission, or the next of kin have to be found in order to determine whether or not there is a living will, or to obtain permission if there is none. This often makes the determination of the possibility of organ donation difficult and time-consuming. This is particularly disadvantageous because in many cases, time plays a decisive role, and organ removal only makes sense if the possibility of it is determined at an early point in time.

The previously known chip card according to the aforementioned German patent application does not make a contribution to the organ donation problem as described above, since it only proposes storing medical/clinical data in addition to the other administrative medical data. All of the personal medical data are supposed to be stored on the card in encrypted form, so that they are useless after the death of a patient who was the sole person authorized to have access to the data.

Furthermore, the use of organ donor IDs that are usually carried by those persons who have given their permission for organ removal is known. However, the number of persons who carry such an ID with them is by far not enough to come even approximately close to the existing demand for donated organs. In contrast, a significantly larger number of persons, namely every member of a statutory health insurance organization, normally carries a patient insurance card. Of course, the possibility of storing the information contained on organ donor IDs on these cards is probably excluded for reasons of data privacy law.

In view of this background, the invention is based on the task of creating possibilities for making the data stored on the patient card accessible even in case of non-responsiveness of the patient. This relates both to medical data stored on the card, and to decisions that the cardholder has made in case of his/her death as well as for the use of life-extending measures.

This task is accomplished by means of a patient card of the type stated initially, in which the card has a sensor field that allows a comparison of a fingerprint with stored fingerprint data, as well as a program control that allows the release of patient data stored in the integrated data memory, if the stored fingerprint data and the detected fingerprint data agree.

Patient cards are intended to be carried by the cardholder, in order to be available in an emergency. If an accident or illness occurs, the personal data of the patient, which serve to identify him/her, can generally be called up without problems from the card. In order to activate the personal patient data and other stored data, activation of the card by way of comparing the fingerprint of the cardholder, for example of the right forefinger, with stored fingerprint data is required. If the patient is responsive, he/she can activate the data personally. If the patient is not responsive, or if there is a life-threatening situation, or if the patient has died, the treating physician, for example, can perform the activation after having determined the patient's status, by way of a comparison of the fingerprint data.

It is practical if the patient card according to the invention has a data display on which the stored data can be displayed. In addition to the data display, at least one function to control the representation of stored data on the display is required. This can consist, for example, of keys for paging up and down, or of a so-called control “rose” that allows paging up and down as well as moving to functions shown on the display, and activating them. In particular, the input and deletion of data with such a control “rose” is also required.

In addition, the patient card according to the invention can have input keys, particularly numerical input keys, such as those known, for example, from calculators in a check-card format.

The card according to the invention is preferably divided up into a flat part and a thicker, heavier part, whereby the former is intended for insertion into a conventional card device and the latter for accommodating electronic components. The flat card part generally has the microchip function, which can be accessed at the contact points in the card reader device. The thicker part having the electronic components has the control electronics, the sensor technology and, if applicable, other modules, as well as the batteries that might be required for operation. A possibility of connecting the card to a cell phone might be practical, for example in order to utilize the power supply of the cell phone for the patient card according to the invention, or also to transmit data from the patient card by phone, for example to an ambulance or a clinic.

As mentioned above, patient cards are intended to be carried by the cardholder. High-risk patients, in particular, will generally always carry their cards with them.

If a fatal accident occurs, for example, the information concerning the living will is available immediately, in order to determine the possibility of organ removal. For example, the complete contents of the living will can be stored centrally. The health insurance organization or a central organ donor register is a possibility for this, for example. The card according to the invention then merely contains a binary data item that exclusively shows whether or not there is a living will. No information about the precise content of the living will is stored, for now. In this case, there should be no concerns of data privacy law to oppose the patient insurance card according to the invention. By storing a single additional binary value, the process for obtaining the required permission for organ removal is also simplified and accelerated significantly. If there is sufficient memory capacity, however, storing decisions in their entirety or in part also does not represent a problem.

An advantageous further development of the chip card according to the invention consists of storing the blood group and other medical emergency data of the cardholder in the data memory of the chip card. In emergency situations, knowing the blood group of a patient can be a deciding factor, particularly if transfusions are required due to blood loss. If the blood group is not known, a test in this regard is required, which takes an undesirably long time. Early knowledge of the blood group can be lifesaving, as can the knowledge of possible medication intolerances, for example.

It is furthermore practical to store diagnosis or medication data in the data memory of the chip card according to the invention, either encrypted or otherwise protected against unauthorized access. Such data are of great benefit in emergency situations, as described above. For reasons of data privacy law, however, the patient-related medical data must be stored in encrypted manner, whereby authorization to access the data in question can be provided by the cardholder himself/herself, who has a password, for example in the form of a PIN, for this purpose. The microprocessor usually present on chip cards allows active implementation of suitable cryptographic methods, so that even if certain access protocols are circumvented, there is no possibility that unauthorized third parties will obtain knowledge about the stored data.

As explained, however, the authorization to access the data content of the chip card by means of a PIN is disadvantageous if the patient is not conscious, in an emergency situation, and therefore cannot himself/herself release access to the required diagnosis and medication data. The present invention therefore proposes either providing the chip card with a program control by means of which encryption and decryption of the patient-related data contained in the data memory are carried out by means of biometric data of the cardholder, particularly by means of fingerprint data, or controlling access to the data content of the chip card by means of the program control, whereby authorization to access the data is determined on the basis of the biometric data of the cardholder. The biometric data can therefore by used essentially as a password to access the patient-related medical data. Authorization for access is determined by the card software, as soon as the cardholder has identified himself/herself by means of his/her fingerprint or retina pattern. In particular, suitable fingerprint scanners are already commercially available at the present time, and can easily be combined with the current chip card reader devices. Even if the cardholder is in a state of unconsciousness, in an emergency situation, it is advantageously possible, according to the invention, to obtain access to the required data by means of his/her fingerprint, for example.

It is furthermore possible to store the entire content of the living will of the cardholder on a chip card that has been secured against unauthorized access, by means of biometric data. The data are securely protected against unauthorized access if the data are encrypted and can only be decrypted by means of the biometric data. Even after the death of the cardholder, it is possible to gain immediate access to the living will, by means of the patient's biometric data, so that it can be determined, within the shortest possible period of time, whether or not the deceased cardholder has given permission for organ removal. The encryption of the living will stored on the card, for example by means of the cardholder's fingerprint or other biometric data, effectively prevents these data from becoming useless upon the patient's death.

A practical further development of the card according to the invention consists of storing data in the data memory that relate to a stem cell deposit of the cardholder. Therapy with stem cells has already established itself in the treatment of leukemia. In the future, therapy with stem cells will gain importance for the regeneration of damaged organs. If a stem cell deposit is documented in the data memory of the card, there is the possibility of finding possible donors of stem cells in simpler manner. Currently, the possibilities of therapies using autologous donated stem cells are also being discussed. It is possible, for example, to obtain stem cells from the umbilical cord blood at birth. These stem cells can then be frozen to preserve them for later therapeutic use. Using the patient insurance card, it can be determined, according to the invention, for every patient and at any time, whether and where stem cells were deposited for such therapy purposes.

For a simple and reliable assignment of a patient insurance card to a cardholder, it is furthermore practical to affix a photograph of the cardholder on the chip card.

The invention will be explained in greater detail, using the following figures.

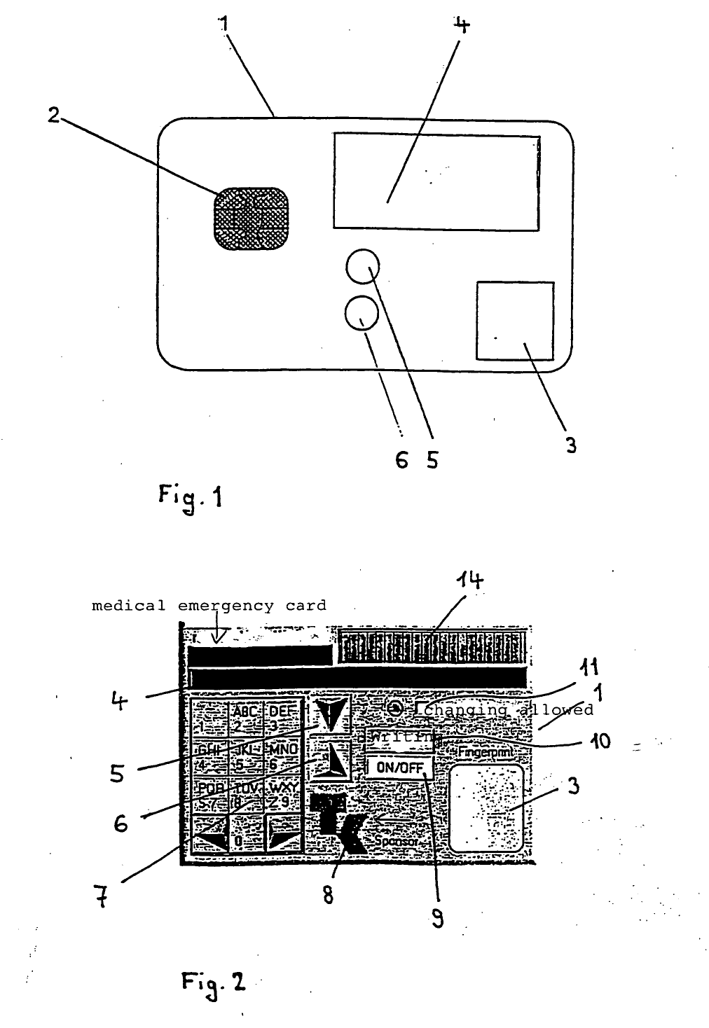

FIG. 1 shows a patient card according to the invention, according to a first embodiment, and

FIG. 2 shows a card according to the invention, which additionally has a keyboard field.

FIG. 1 shows a patient card 1, which has the format of a check card and consists of plastic material. A chip 2, the contact surfaces of which are visible on the top of the card, is integrated into the card. On the surface of the carrier material of the chip card 1, various imprints can be applied, which reproduce or supplement the data stored on the chip 2, at least in part. Possible imprints are, for example, the name, the name of the health insurance organization, in each instance, possibly with a logo, as well as an insurance number, for example, which indicates the health insurance organization. In addition, there can be a number for the insured, which indicates the insured status, for example. Furthermore, the statement of an expiration date and the integration of a photograph of the cardholder are also possible.

The essential functions of the card include a sensor field 3, in order to identify a finger that is held on this field, by means of its line pattern, by comparing it with a pattern stored in memory. The number 4 refers to a display on which the stored data can be shown. The functions 5 and 6 serve to turn the electronic functions on and off, respectively, as well as to page up and down in the data being shown in the display 4.

FIG. 2 shows another variant of the patient card according to the invention, in which the microchip is fully integrated and cannot be touched from the outside. The cards themselves can be input by way of a keyboard 7 and shown on a display 4. The keyboard 7 is a keyboard such as that usually used in check-card calculators or telephones. Additional function keys 5 and 6 serve to page up and down in the data being shown on the display-4.

The number 8 represents the logo of the insurance organization, the number 9 is an on/off switch. Writing is activated with the key 10, unless the card is blocked for modification of the data stored on it, which is evident from the data field 11. The number 14 refers to a solar cell field for the energy supply, unless the card is operated with an external energy source or with batteries.

1-15. (canceled).

16. Patient card (1) having a microchip (2), in the integrated data memory of which personal data of a patient are stored, comprising
a sensor field (3) that allows a comparison between a fingerprint and fingerprint data stored in memory, and
a data display (4),
characterized by a program control that allows the release of patient data stored in the integrated data memory if the stored and detected fingerprint data agree, for the purpose of making personal data of a patient available in the case of non-responsiveness or the death of the patient, and which controls the display of the stored patient data on the data display (4), in case of release.

17. Patient card according to claim 16, characterized by keys for paging up and down in the displayed data on the display (4), and/or a control button for setting and activating functions displayed on the display (4).

18. Patient card according to claim 16, wherein the card (1) has a flat part and a thick part, whereby the former is intended for insertion into a card reader device and the latter for accommodating electronic components.

19. Patient card according to claim 16, wherein it is designed for battery operation.

20. Patient card according to claim 16, wherein it has a possibility for a connection to a cell phone.

21. Patient card according to claim 16, wherein the connection possibility serves for a power supply from the cell phone and/or for data transmission to the cell phone.

22. Patient card according to claim 16, wherein diagnostic and/or medication data are stored in the data memory, in encrypted form or otherwise protected against unauthorized access.

23. Patient card according to claim 22, wherein the card (1) has a program control by means of which encryption and decryption of patient-related data contained in the data memory are performed, using the fingerprint data.

24. Patient card according to claim 16, wherein data of a living will are stored in the data memory.

25. Patient card according to claim 16, wherein data that relate to a stem cell deposit of the cardholder are stored in the data memory.

26. Patient card according to claim 16, wherein immunology data of the patient are stored in the data memory.

27. Method for making available personal data of a patient in the case of non-responsiveness or the death of the patient, using a patient card according to claim 16, whereby a comparison of the fingerprint of the non-responsive or dead patient is compared with the fingerprint data stored in the integrated data memory of the card (1), using the sensor field (3) of the card (1), and whereby the release of the patient data stored in the integrated data memory is then controlled by means of the program control of the card, if the stored and the detected fingerprint data match.

28. Use of a patient card according to claim 16 for making available personal data of a patient in the case of non-responsiveness or the death of the patient.

29. Use according to claim 28, for making available data of a living will stored in the data memory of the card.

30. Use according to claim 28, for making available data that relate to a stem cell deposit of the cardholder.

31. Use according to claim 28, for making available immunology data of the patient.

32. Use according to claim 28, for making available diagnostic and/or medication data that are stored in the integrated data memory of the card (1), in encrypted form or otherwise protected against unauthorized access.

33. Use according to claim 28, whereby the card (1) has a program control by means of which encryption and decryption of patient-related data contained in the data memory are performed, using the fingerprint data.

34. Use according to claim 28, whereby the card (1) has a data display (4) on which the stored patient data can be displayed in case of release.

35. Use according to claim 34, whereby the card (1) has at least one function (5, 6) for controlling the representation of stored data on the display (4).
